(19) United States
(12) Patent Application Publication
(10) Pub. No.: US 2022/0194508 A1
(43) Pub. Date: Jun. 23, 2022

(54) ARTICULATED BIKE MITTS

(71) Applicant: Rad Power Bikes Inc., Seattle, WA (US)

(72) Inventors: Trevor KNAPP, Seattle, WA (US); Cory TSAI, Seattle, WA (US)

(21) Appl. No.: 17/208,543

(22) Filed: Mar. 22, 2021

Related U.S. Application Data
(60) Provisional application No. 63/130,302, filed on Dec. 23, 2020.

(51) Int. Cl. B62J 23/00; B62J 17/00; B62J 33/00

(52) U.S. Cl. CPC B62J 23/00; B62K 21/12; B62J 33/00; B62J 17/00

(57) ABSTRACT

Articulated bicycle mitts, bike mitts, or pogies, are described. In some embodiments, the configuration of the bike mitts enables the mitts to be utilized on or with various different handlebars, including handlebars having different bar types, sizes, shapes, geometries, and/or orientations. For example, the bicycle mitts, being articulated, include a single base layer, or an outer layer (e.g., a weather protective or protection layer) that flexes or takes on a shape that is dependent on a bar type (e.g., flat bar or swept back) for handlebars to which the mitts are attached. In some embodiments, the base layer or outer layer includes a hinge located at an outer edge of the layer, which facilitates movement of the mitts (e.g., a first section with respect to a second section) based on the bar type of the handlebars of the bicycle.

### CROSS REFERENCE TO RELATED APPLICATIONS

This application claims priority to U.S. Provisional Patent Application No. 63/130,302, filed on Dec. 23, 2020, entitled ARTICULATED BIKE MITTS, which is hereby incorporated by reference in its entirety.

### BACKGROUND

Electric bicycles, or e-bikes, are a popular method of transportation for use by individual riders, families, commercial enterprises and fleets, and so on. Unlike traditional bikes, an e-bike provides assisted modes of travel to a rider, including a peddle assist mode that utilizes power from a motor to assist the rider in pedaling and/or a throttle mode where the motor, when engaged, powers the e-bike without any pedaling from the rider.

Often, electric bicycles (and other bicycles) are used in cold, damp, or wintry conditions, where accessories, such as gloves or mitts, are worn by a rider to keep their hands warm and/or dry. However, such accessories are often designed specifically for certain bikes, and thus can be expensive and of limited use to a rider of multiple bicycles. These and other problems exist with respect to conventional mitts and gloves designed for use with bicycles, such as electric bicycles.

### BRIEF DESCRIPTION OF THE DRAWINGS

Embodiments of the present technology will be described and explained through the use of the accompanying drawings.

FIG. 1 is a diagram illustrating a pair of articulated bicycle mitts.

FIG. 2 is a diagram illustrating various attachment components of the articulated bicycle mitts.

FIGS. 3A-3B is a diagram illustrating a pair of articulated bicycle mitts attached to the handlebars of an electric bicycle.

FIG. 4 is a diagram illustrating a bike mitt attached to handlebars having a flat bar type of configuration.

FIG. 5 is a diagram illustrating a bike mitt attached to handlebars having a swept back type of configuration.

FIGS. 6A-6B are diagrams that illustrate movement of a hinge of a bike mitt when the bike mitt is attached to handlebars having different bar type configurations.

In the drawings, some components are not drawn to scale, and some components can be combined for discussion of some of the implementations of the present technology. Moreover, while the technology is amenable to various modifications and alternative forms, specific implementations have been shown by way of example in the drawings and are described in detail below. The intention, however, is not to limit the technology to the particular implementations described. On the contrary, the technology is intended to cover all modifications, equivalents, and alternatives falling within the scope of the technology as defined by the appended claims.

### DETAILED DESCRIPTION

Articulated bicycle mitts, bike mitts, or pogies, are described. In some embodiments, the configuration of the bike mitts enables the mitts to be utilized on or with various different handlebars, including handlebars having different bar types, sizes, shapes, geometries, and/or orientations.

For example, the bicycle mitts, being articulated, include material (e.g., a weather resistant or protection material) that flexes or takes on a shape that is dependent on a bar type (e.g., flat bar or swept back) for handlebars to which the mitts are attached. In some embodiments, the material, base layer, or body, includes a hinge located at an outer edge of the layer, which facilitates movement of the mitts (e.g., a first section with respect to a second section) based on the bar type of the handlebars of the bicycle.

Thus, in some embodiments, an articulated bicycle mitt can include a hinge that facilitates a first section of the mitt to move with respect to a second section of the mitt. The hinge of the bike mitt can include an inner layer or portion formed of a first flexible material, and an outer layer formed of a second flexible material that is configured to move between a closed or flexed position and an open position, depending on a bar type of handlebars to which the mitt is attached or fixed.

In some embodiments, the articulated bicycle mitt, which is configured to be attached to different handlebars having different handlebar geometries, includes an insulating layer that forms a pocket to receive a hand of a rider of a bicycle when the rider of the bicycle grips handlebars of the bicycle, and an exterior shell layer, disposed around the insulating layer, that includes an articulated section that adjusts to accommodate a bar type of the handlebars of the bicycle.

While described herein with respect to an electric bicycle, in some embodiments aspects of the bicycle mitts described herein can be configured or utilized with other bicycles or cycles, electric scooters or other wheeled micro-mobility vehicles, mopeds, and so on. Thus, the bicycle mitts, in some embodiments, can be configured to attached to any or all vehicles having handlebars.

Various embodiments of the bike mitts or pogies will now be described. The following description provides specific details for a thorough understanding and an enabling description of these embodiments. One skilled in the art will understand, however, that these embodiments may be practiced without many of these details. Additionally, some well-known structures or functions may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments.

### Examples of the Articulated Bike Mitts

As described herein, the articulated bike mitts or pogies, via their construction, can be adapted for use with various types or shapes of handlebars, including handlebars on electric bicycles that carry brakes, shifters, control devices, displays, and so on.

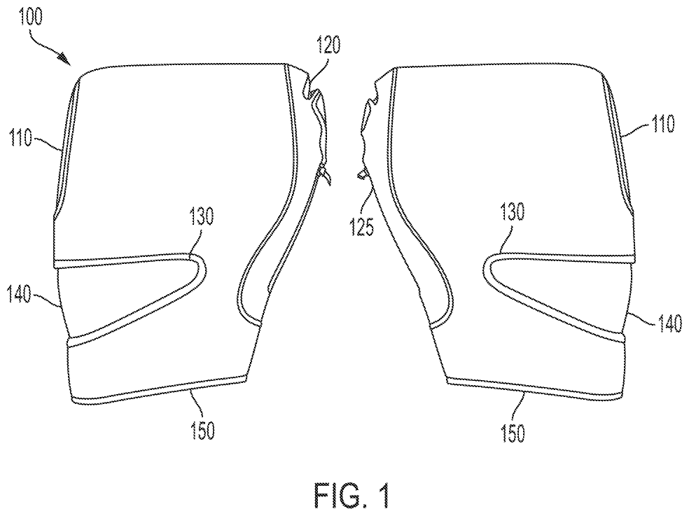

FIG. 1 is a diagram illustrating a pair of articulated bicycle mitts 100. Each of the articulated bicycle mitts 100 (e.g., a left mitt and a right mitt) includes a base layer, material or body 110. The body material 110 is formed of weatherproof or weather resistant material, such as materials that protect a rider's hands from water, wind, low temperatures, and so on. For example, the body material 110 can be formed of one or more layers of flexible materials, such as foam rubber (e.g., Neoprene) Gore-Tex™, and other materials, shells, or fabrics suitable for preventing or blocking the elements from entering the mitts 100 and keep a rider's hands warm.

To suitably provide protection from the elements, the body or base material 110 can be formed of one or multiple pieces that attach at seams via serger stitching, or other similar techniques. The body 110, in some cases, is attached or bonded to an inner layer 140 or liner, such as a flexible insulating layer or material. Further, the body 110 can include reflective elements or materials provided on an outer surface, such as elements positioned to provide visibility for the rider when riding in the dark.

The body material 110 is, in some embodiments, a flexible, insulating layer, and functions to keep the hands of the bicycle rider warm when they are riding in cold and wet or wintering environments. This body material, in some cases, can be formed of various synthetic or natural materials, such as down material, fleece material, cotton material, polyester, and so on.

Further, the body material 110 provides a pocket, enclosure, or inner area that receives or encloses a hand of the rider of the bicycle when the rider of the bicycle grips the handlebars of the bicycle. The body 110, thus, facilitates covering and maintaining a warm temperature for the rider when they are gripping the handlebars of the bicycle.

The body 110 include openings that facilitate the placement of the mitts 100 onto the handlebars and the attachment of the mitts 100 to the handlebars such that the mitts 100 accommodate cables or other handlebar mounted components. The body or base material 110 includes an opening 120, which facilitates sliding or otherwise fixing the mitts 100 to the handlebars. The opening 120 can include a zipper (e.g., a reverse coated zipper), which opens and closes to assist in attaching the mitts 100 to the handlebars, and/or a Velcro fastener, providing a tight fit with the cables and bar when the mitts 100 are attached.

The mitts also include an articulated section 130. The articulated section 130, in some embodiments, includes a hinge (e.g., a V-shaped configuration), formed within the base or body 110, which provides flexibility to the mitts 100 when they are attached to the handlebars. The articulated section 130, in some cases, has a portion of the base or body 110 removed, and includes an inner layer 140 or other internal section of flexible material within the articulated section 130. Thus, the inner portion 140 of the hingle is visible via the open portion of the articulated section 130. Given this visibility, the mitts 100 can provide various colorful combinations of layers or different materials, where the inner portion 140 has a color or material different than the base or body 110.

The articulated section 130 enables sections of the base or body 110 to move with respect to one another, depending on a bar type or bar geometry for the handlebars to which the mitts 100 are attached. Further, given that only a small portion of the base or body 110 is removed, and is filled in by the inner section 140 (e.g., the base or body 110 substantially covers a rider's hand and arm), the use of the articulated section 130 enables the mitts 100 to mount to different handlebar types without sacrificing their weather protection functionality. Additional details regarding the articulated section 130 and hinge are described herein.

Further, the articulated bicycle mitts 100 include arm cuffs 150, or openings that facilitate entry of the arms of the rider of the bicycle within the mitts 100. The arm cuffs 150 may include material that provides additional protection, such as a fleece edge, as well as materials that provides a rigid entry to facilitate the rider placing their hands into the mitts 100. In some, cases, when the mitts 100 are worn by the rider (when the rider grips the handlebars), the articulated section 130 is positioned proximate to a wrist of the rider, and the cuffs 150 are positioned along a forearm of the rider.

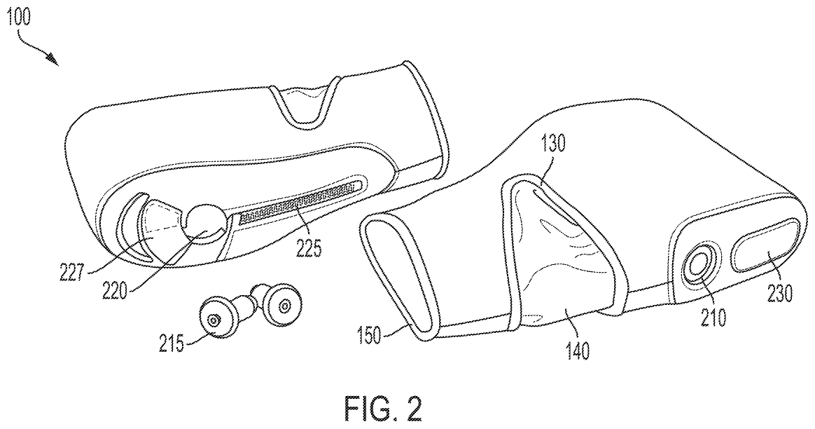

FIG. 2 is a diagram illustrating various attachment components of the articulated bicycle mitts 100. As described herein, the mitts 100 includes openings that facilitate the attachment (and removal) to handlebars. For example, a handlebar hold component 210, such as a disc, positioned on an outer edge or section of the mitts 100, receives an end of the handlebars when they are positioned within the mitts 100. An end plug 215, such as a locking bar end plug (or other locking mechanism), slides through the hold component 210 to lock a mitt to the end of the handlebars (e.g., locking with the disc).

The mitts 100 also include a bar opening 220 (e.g., similar to the bar opening 120), which acts to facilitate securement or attachment or otherwise fixing the mitts 100 to the handlebars, The bar opening 220 can be opened or closed using a zipper mechanism 225, which enables opening of the mitts 100 during their placement onto handlebars, as well as the accommodation of cables, braking systems, shifting systems, and so on, which are disposed on the handlebars and at least partially enclosed by the mitts 100. In some cases, Velcro or other attachment mechanisms 227 can be utilized to secure the mitts 100 to the handlebars. Further, the mitts 100, as described herein, can include other elements on the outer surface, such as reflective elements 230, branding or patterns, and so on.

In some cases, the layers can include a transparent section that facilitates the rider viewing one or more components of the bicycle positioned on the handlebars when the bike mitt is attached to the handlebars of the bicycle. For example, the transparent section can provide a view into the brakes, shifting components, control devices (for electric bicycles), displays, pedometers and other tracking devices, and so on.

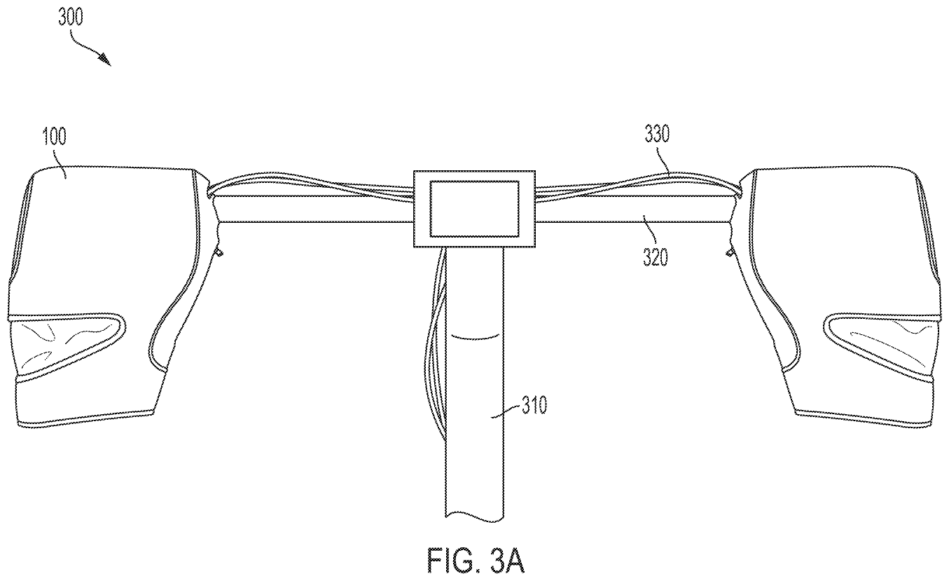

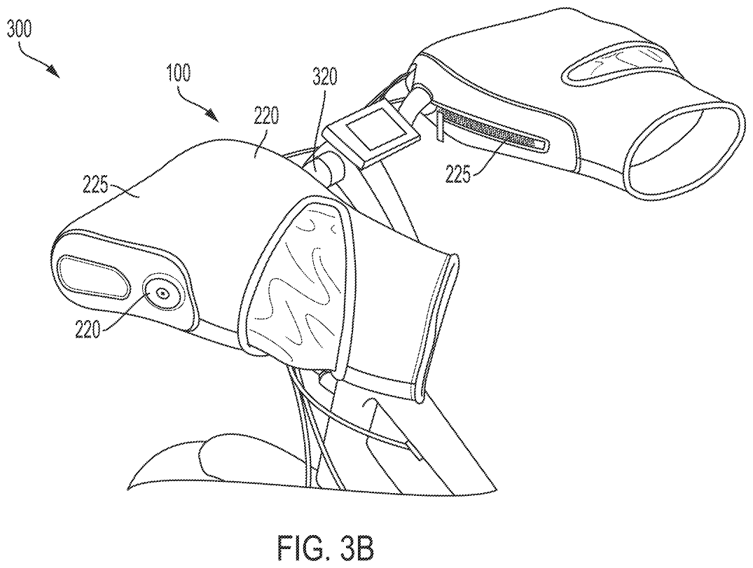

FIGS. 3A-3B are diagrams 300 illustrating the pair of articulated bicycle mitts 100 attached to handlebars 320 of an electric bicycle 310. As shown, the mitts 100 include the hard rubber disc 220 that connects the mitts 100 to the handlebars 320, and the zipper 225 that, when closed, allows cables 330 from the handlebars 320 to run into the mitts 100 when they are attached to the handlebars 320.

As described herein, the articulated bicycle mitts 100 are capable of being attached to different handlebar types, including flat bar types, swept back bar types, riser bar types, and other geometries. For example, the mitts 100 can be attached to handlebars having a sweep of 0-45 degrees. Further, the mitts 100 can be attached to handlebars having any amount of vertical rise, such as handlebars having zero or minimal rise.

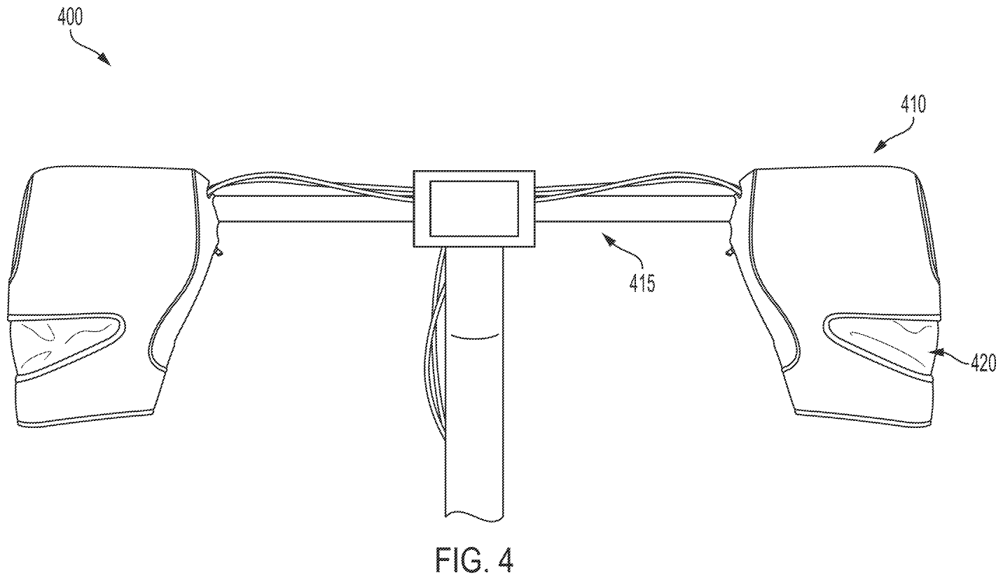

FIG. 4 is a diagram 400 illustrating a bike mitt 410 attached to handlebars 415 having a flat bar type of configuration. The bike mitt 410 is attached to the flat bar handlebars 415, and a hinge 420 maintains an open configuration. For example, because the handlebars 415 are a flat type, they are generally perpendicular to the arms of the rider when the rider grips the handlebars 415. Thus, the bike mitt 410 does not change shape to adjust for or accommodate the angle of the handlebars with respect to the arms of the rider when gripping the handlebars 415.

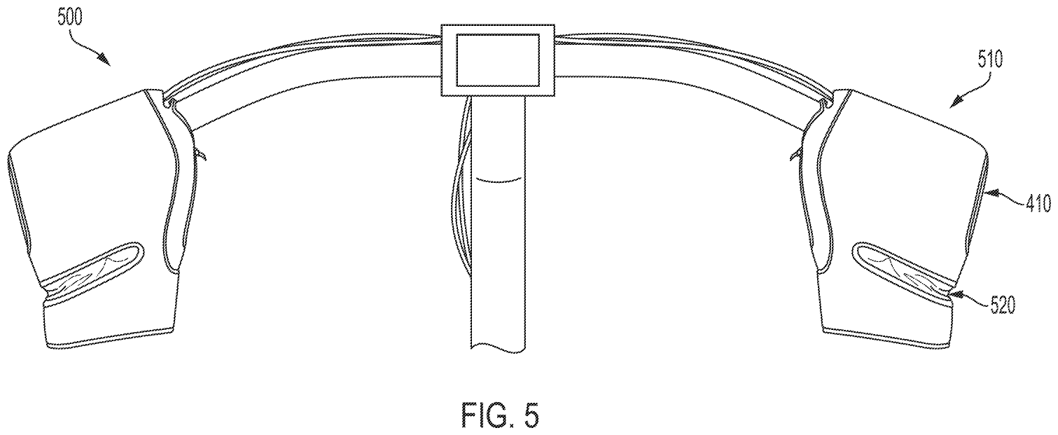

In contrast, FIG. 5 is a diagram 500 illustrating the bike mitt 410 attached to handlebars 510 having a swept back, or angled, type of configuration. Because the bike mitt 410 is attached to the angled handlebars 510, a hinge 520 maintains a flexed or closed (or partially closed) configuration. For example, because the handlebars 510 are angled (e.g., not at 0 degrees, such as 15-35 degrees sweep), they are not generally perpendicular to the arms of the rider when the rider grips the handlebars 510. Instead, the arms of the rider form an angle with the handlebars that is greater than 90 degrees. Thus, the bike mitt 410 changes shape, via the hinge 520 to adjust for or accommodate the angle of the handlebars with respect to the arms of the rider when gripping the handlebars 510.

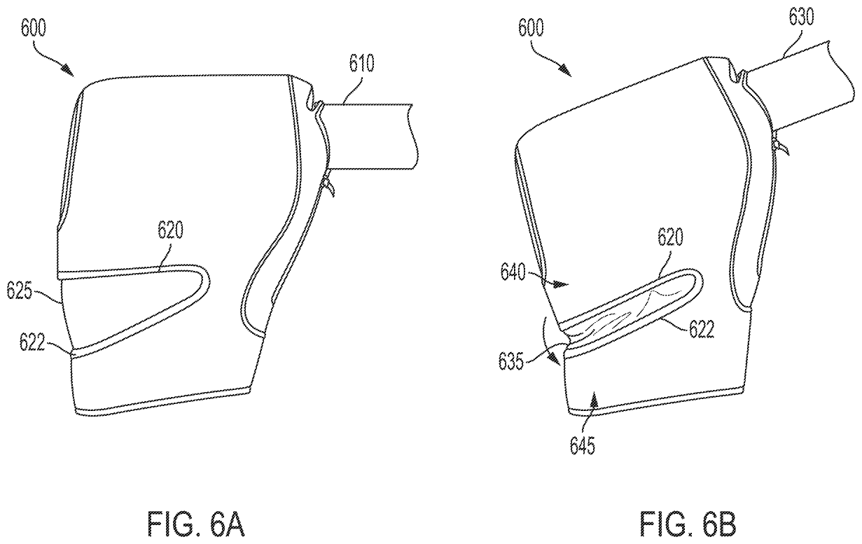

FIGS. 6A-6B are diagrams that illustrate movement of a hinge 620 of a bike mitt 600 when the bike mitt 600 is attached to handlebars having different bar type configurations. As depicted in FIG. 6A, the bike mitt 600 is attached to a flat bar 610. The hinge 620, which includes an edge 622 or boundary portion, maintains an open position 625.

However, when the bike mitt 600 is attached to an angled bar 630 (e.g., the swept back type bar), the edge 622 of the hinge 620 moves inward towards itself (depicted by the arrow), and the hinge maintains a closed, or flexed, position 635. For example, the hinge 620 facilitates a first section 640 of the outer layer of the mitt 600 (e.g., a section that attaches to the handlebars) to move with respect to (e.g., closer to) a second section 645 of the outer layer (e.g., a section that receives an arm of a rider).

In some cases, the hinge is part of a single layer mitt, providing flexibility to the single layer, as well as a covering or inner hinge layer or material within the hinge (e.g., where the hinge flexes). In other cases, the hinge is part of an outer or protection layer of a dual layer mitt, and the inner layer (e.g., insulating layer), is partially exposed via the hinge.

As described herein, the hinge, or articulated section, can be disposed or placed such that an opening formed by the hinge faces away from the rider of the bicycle. In other configurations, the hinge can include a smaller opening, or an opening having different shapes or geometries. Further, as described herein, the articulated section can include a covering material for the opening (e.g., to cover an exposed inner layer), in order to provide the flexibility for articulation, while also maintaining warmth or dryness in certain conditions or environments.

Via such movement, and the placement of the hinge, or articulated section, the bike mitts provide articulation, and thus the flexibility to be mounted or attached to different handlebar types, sizes, or configurations. Thus, the articulated bicycle mitts described herein can be utilized on multiple different bicycles, reducing costs to riders and providing additional usefulness, among other benefits.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or”, in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the electric bike and bike frame may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

From the foregoing, it will be appreciated that specific embodiments have been described herein for purposes of illustration, but that various modifications may be made without deviating from the spirit and scope of the embodiments. Accordingly, the embodiments are not limited except as by the appended claims.

What is claimed is:

1. An articulated bicycle mitt, comprising:
a base layer formed of a flexible material,
wherein the base layer is shaped to receive a hand of a rider of a bicycle to which the articulated bicycle mitt is attached when the rider of the bicycle grips handlebars of the bicycle; and
a hinge disposed within the base layer that facilitates a first section of the base layer to move with respect to a second section of the base layer.

2. The articulated bicycle mitt of claim 1, wherein the first section of the base layer includes:
a locking mechanism that locks the articulated bicycle mitt to the handlebars of the bicycle when the articulated bicycle mitt is attached to the handlebars of the bicycle; and
a zipper that, when in an open position, facilitates attachment of the articulated bicycle mitt to the handlebars and that, when in a closed position, fixes the articulated bicycle mitt to the handlebars when the articulated bicycle mitt is attached to the handlebars.

3. The articulated bicycle mitt of claim 1, wherein the hinge is disposed between the first section of the base layer and the second section of the base layer and includes a covering material that is different from the flexible material of the base layer.

4. The articulated bicycle mitt of claim 1, wherein the hinge includes an opening that facilitates access to an inner layer of the articulated bicycle mitt that is disposed within the base layer of the articulated bicycle mitt.

5. The articulated bicycle mitt of claim 1, wherein the hinge is positioned in an open configuration when the articulated bicycle mitt is attached to handlebars having a flat bar type design and positioned in a closed configuration when the articulated bicycle mitt is attached to handlebars having a swept back type design.

6. The articulated bicycle mitt of claim 1, wherein the hinge is disposed at a position of the articulated bicycle mitt that is proximate to a wrist of the rider when the hand of the rider is within the base layer of the articulated bicycle mitt.

7. The articulated bicycle mitt of claim 1, wherein the hinge is disposed such that an opening formed by the hinge faces away from the rider of the bicycle.

8. The articulated bicycle mitt of claim 1, wherein the flexible material of the base layer includes an insulating material.

9. The articulated bicycle mitt of claim 1, wherein the flexible material of the base layer includes a weather protective material.

10. The articulated bicycle mitt of claim 1, wherein an outer surface of the base layer includes light reflective elements.

11. A bike mitt, comprising:
an inner layer that receives a hand of a rider of a bicycle when the rider of the bicycle grips handlebars of the bicycle; and
an outer layer disposed around the inner layer and configured to attach the bike mitt to the handlebars of the bicycle,
wherein the outer layer includes an articulated section that facilitates a first section of the outer layer to move with respect to a second section of the outer layer.

12. The bike mitt of claim 11, wherein the articulated section includes a hinge formed on an outer edge of the outer layer of the bike mitt.

13. The bike mitt of claim 11, wherein the articulated section sits in an open configuration when the bike mitt is attached to handlebars having a flat bar type design and sits in a closed configuration when the bike mitt is attached to handlebars having a swept back type design.

14. The bike mitt of claim 11, wherein the articulated section facilitates movement of the first section with respect to the second section based on an angle of the handlebars of the bicycle.

15. The bike mitt of claim 11, wherein the articulated section is disposed at a vertical position of the bike mitt that is proximate to a wrist of the rider when the rider grips the handlebars of the bicycle.

16. The bike mitt of claim 11, wherein the inner layer includes a natural insulating material.

17. The bike mitt of claim 11, wherein the outer layer includes a rubber foam protective material.

18. The bike mitt of claim 11, wherein the inner layer and the outer layer both include a transparent section that facilitates the rider viewing one or more components of the bicycle positioned on the handlebars when the bike mitt is attached to the handlebars of the bicycle.

19. A bike mitt configured to be attached to different handlebars having different handlebar geometries, the bike mitt comprising:
an insulating layer that forms a pocket to receive a hand of a rider of a bicycle when the rider of the bicycle grips handlebars of the bicycle; and
an exterior shell layer, disposed around the insulating layer, that includes an articulated section that adjusts to accommodate a bar type of the handlebars of the bicycle.

20. The bike mitt of claim 19, wherein the articulated section includes a hinge that is disposed on an outer edge of the exterior shell layer and facilitates movement of a first section of the bike mitt with respect to a second section of the bike mitt based on the bar type of the handlebars of the bicycle.
